(19) United States
(12) Patent Application Publication
(10) Pub. No.: US 2025/0246734 A1
(43) Pub. Date: Jul. 31, 2025

(54) BATTERY PACK

(71) Applicant: TOYOTA JIDOSHA KABUSHIKI KAISHA, Toyota-shi (JP)

(72) Inventors: Kotaro HORIGUCHI, Toyota-shi (JP); Takuya MORIOKI, Toyota-shi (JP)

(73) Assignee: TOYOTA JIDOSHA KABUSHIKI KAISHA, Toyota-shi (JP)

(21) Appl. No.: 18/999,099

(22) Filed: Dec. 23, 2024

(30) Foreign Application Priority Data
Jan. 26, 2024 (JP) 2024-010426

(51) Int. Cl. H01M 50/233; H01M 50/209

(52) U.S. Cl. CPC H01M 50/233; H01M 50/209

(57) ABSTRACT

A battery pack includes: a plurality of battery cells stacked in a predetermined direction; an upper frame member disposed above the battery cell; and a lower frame member disposed below the battery cell. Further, the upper frame member includes a reinforcing member extending in a direction perpendicular to a stacking direction of the battery cells, and at least a part of the reinforcing member overlaps the lower frame member.

### CROSS-REFERENCE TO RELATED APPLICATION(S)

The present application claims priority to and incorporates by reference the entire contents of Japanese Patent Application No. 2024-010426 filed in Japan on Jan. 26, 2024.

### BACKGROUND

The present disclosure relates to a battery pack.

Japanese Laid-open Patent Publication No. 2015-137008 discloses the structure with improved maintainability, in which, the under cover disposed below the battery pack is fastened to the battery pack and is provided with a cover piece not covering the battery fastening position from below.

A frame member is disposed between each battery cell of the battery pack. In such a battery pack, in the portion where the battery cells are arranged on both sides of the frame member, for example, when the side thrust load from the outside is input, the load input through the frame member, evenly in the battery cells on both sides It will be carried.

### SUMMARY

There is a need for providing a battery pack capable of suppressing buckling of the frame member.

According to an embodiment, a battery pack includes: a plurality of battery cells stacked in a predetermined direction; an upper frame member disposed above the battery cell; and a lower frame member disposed below the battery cell. Further, the upper frame member includes a reinforcing member extending in a direction perpendicular to a stacking direction of the battery cells, and at least a part of the reinforcing member overlaps the lower frame member.

### BRIEF DESCRIPTION OF THE DRAWINGS

FIG. 1 is a plan view illustrating a configuration of a battery pack according to an embodiment;

FIG. 2 is an enlarged plan view of the X portion of the battery pack of FIG. 1;

FIG. 3 is a cross-sectional view illustrating a condition in which the battery pack of FIG. 2 is cut at a position of A-A line;

FIG. 4 is a cross-sectional view illustrating a related-art battery pack that is cut at the same position as A-A line of FIG. 2;

FIG. 5 is a cross-sectional view illustrating a condition in which the battery pack of FIG. 2 is cut at the position of B-B line;

FIG. 6 is a plan view illustrating the configuration of a related-art battery pack;

FIG. 7 is a plan view illustrating a configuration of a battery pack according to an embodiment;

FIG. 8 is a cross-sectional view illustrating a condition in which the battery pack of FIG. 6 is cut at the position of C-C line;

FIG. 9 is a cross-sectional view illustrating a condition in which the battery pack of FIG. 6 is cut at the position of D-D line; and

FIG. 10 is a cross-sectional view illustrating a condition in which a battery pack of FIG. 7 is cut at a position of E-E line.

### DETAILED DESCRIPTION

In the related art, in the battery cell disposed at the most end of the battery pack, that is, in a portion in which the battery cell is disposed only on one side of the frame (skeleton) member, for example, when a side thrust load is input from the outside, the load input through the frame member will be carried by only one side of the battery cell. Therefore, at the time of input of the side collision load, the frame member is buckled in the direction in which the battery cell is not disposed (“<” shaped folding), there is a possibility that an excessive load is input to the battery cell.

A battery pack according to an embodiment of the present disclosure will be described with reference to the drawings. In addition, components in the following embodiments include those which can be substituted and easily by those skilled in the art, or those which are substantially the same.

The battery packs according to the embodiment, is used as a battery of a vehicle such as, but not limited to, a Hybrid Electric Vehicle (HEV), a Plug-in Hybrid Electric Vehicle (PHEV), and a Battery Electric Vehicle (BEV).

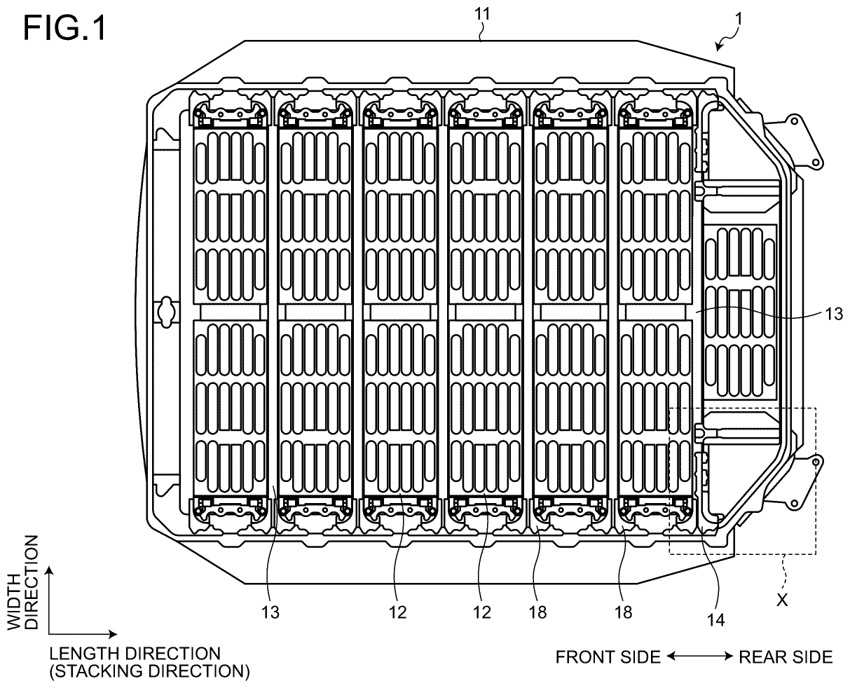

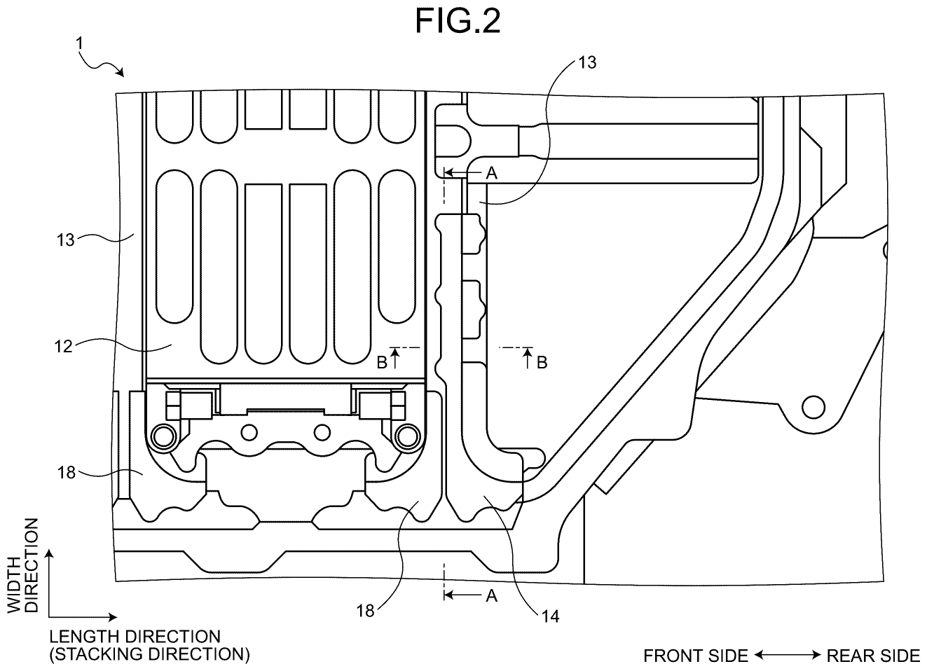

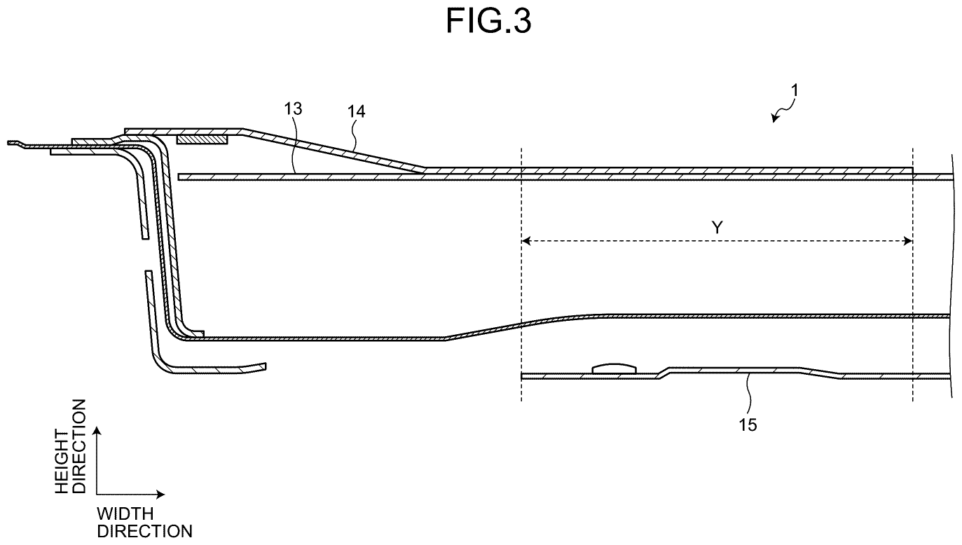

FIG. 1 illustrates a state of removing the upper cover (lid member) from the battery pack according to the embodiment. Further, FIG. 2 illustrates an enlarged state of the X portion of the battery pack in FIG. 1. Further, FIG. 3 illustrates the battery pack in FIG. 2 cut at the state of A-A line.

The battery pack 1 includes a lower case (housing member) 11, a plurality of battery cells 12, a plurality of upper frame member 13, a reinforcing member 14, a plurality of lower frame member 15, a share panel 16, and a connecting member 18.

The lower case 11 is for accommodating each member of the battery pack 1. The battery cells 12 are, for example, liquid-based batteries such as lithium-ion secondary batteries. The battery cells 12 constitute a battery module by being stacked in the length direction of the battery pack 1.

The upper frame member 13 is a member constituting a frame in the lower case 11. The upper frame member 13 is a rod-shaped member extending in the width direction of the battery pack 1 as illustrated in FIG. 1. The upper frame member 13 is disposed above the battery pack 1 in the height direction with respect to the battery cell 12. Incidentally, “the height direction of the battery pack 1” indicates a direction (the thickness direction of the battery pack 1) perpendicular to the length direction and the width direction of the battery pack 1 illustrated in FIG. 1.

Further, the upper frame member 13, as illustrated in FIGS. 1 and 2, in the stacking direction of the battery cell 12 (the length direction of the battery pack 1), is provided on the side surface of the plurality of battery cells 12. The upper frame member 13, as illustrated in FIG. 2, is provided with a reinforcing member 14.

The reinforcing member 14 is for reinforcing the upper frame member 13. The reinforcing member 14, as illustrated in FIG. 2, extends in a direction perpendicular to the stacking direction of the battery cell 12 (the length direction of the battery pack 1), i.e. the width direction of the battery pack 1. Further, the reinforcing member 14, in the stacking direction of the battery cell 12 is provided on the outside of the battery cell 12 disposed at the most end. Note that “the battery cell 12 disposed at the most end” indicates the battery cell 12 disposed at the most rear side of the vehicle, as illustrated in FIG. 2. That is, the “battery cell 12 disposed at the most end” indicates a battery cell 12 in which the other battery cell 12 is disposed only on one side (left side in FIG. 2) and the other battery cell 12 is not disposed on the opposite side (right side in FIG. 2).

Further, as illustrated in the Y portion of FIG. 3, the reinforcing member 14 at least partially wraps with the lower frame member 15. Note that “the reinforcing member 14 and the lower frame member 15 lap” indicates that the reinforcing member 14 and the lower frame member 15 overlap in the height direction of the battery pack 1.

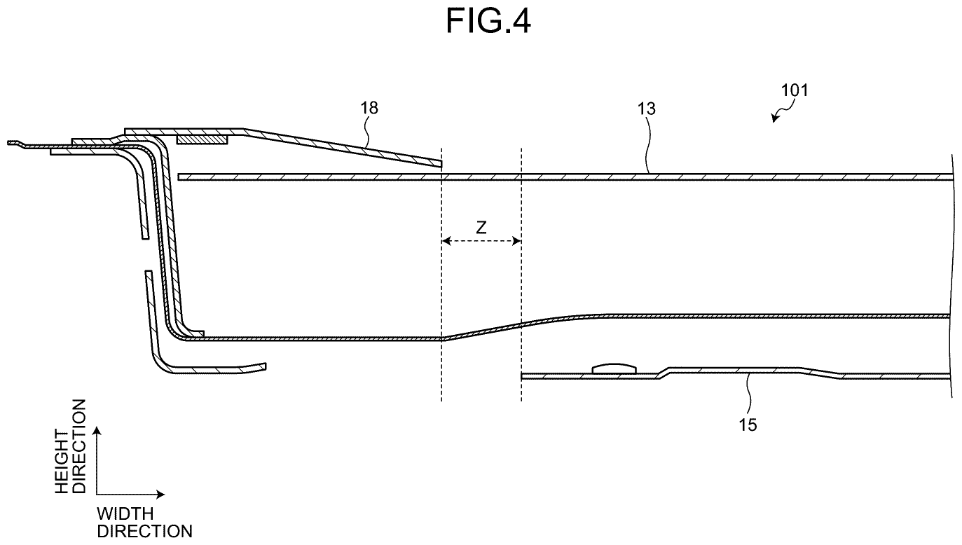

Here, the related-art battery pack 101, as illustrated in FIG. 4, is not provided with a reinforcing member 14, the connecting member 18 is provided at a position corresponding to the reinforcing member 14. Then, the connecting member 18 is not wrapped with the lower frame member 15. Therefore, for example, when the side thrust load is input from the outside, as illustrated by the Z portion in FIG. 4, the gap portion between the connecting member 18 and the lower frame member 15 becomes weak portion (fracture start point), there is a possibility that the upper frame member 13 is buckled.

On the other hand, in the battery pack 1 according to the embodiment, as illustrated in the Y portion of FIG. 3, at least a part of the reinforcing member 14 is lapped with the lower frame member 15, thereby eliminating a weak portion (refer to the Z portion of FIG. 4) like the related-art battery pack 101. Thus, even when the side thrust load is input from the outside, it is possible to suppress the buckling of the upper frame member 13.

Like the upper frame member 13, the lower frame member 15 is a member constituting a frame in the lower case 11. Like the upper frame member 13, the lower frame member 15 is a rod-shaped member extending in the width direction of the battery pack 1. Further, the lower frame member 15 is disposed below the battery cell 12 in the height direction of the battery pack 1.

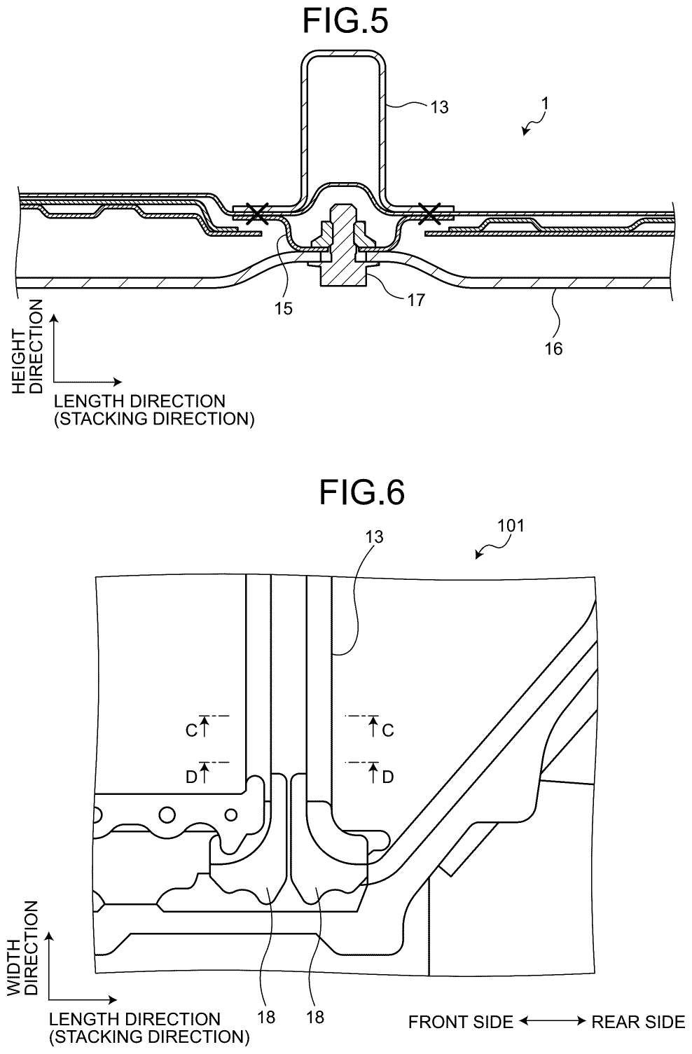

Further, the lower frame member 15, as illustrated in FIG. 5, are fastened by the share panel 16 and the fastening member 17. The share panel 16 is for protecting the lower surface of the battery cell 12 is disposed at the bottom of the lower case 11.

The connecting member 18 supports the upper frame member 13, and is for connecting the upper frame member 13 to each other. The connecting member 18, as illustrated in FIG. 1, is disposed at the end of the upper frame member 13 between the respective battery cells 12. Further, as illustrated in FIG. 2, in the stacking direction of the battery cell 12, on the outside of the battery cell 12 disposed at the most end, the reinforcing member 14 is disposed instead of the connecting member 18.

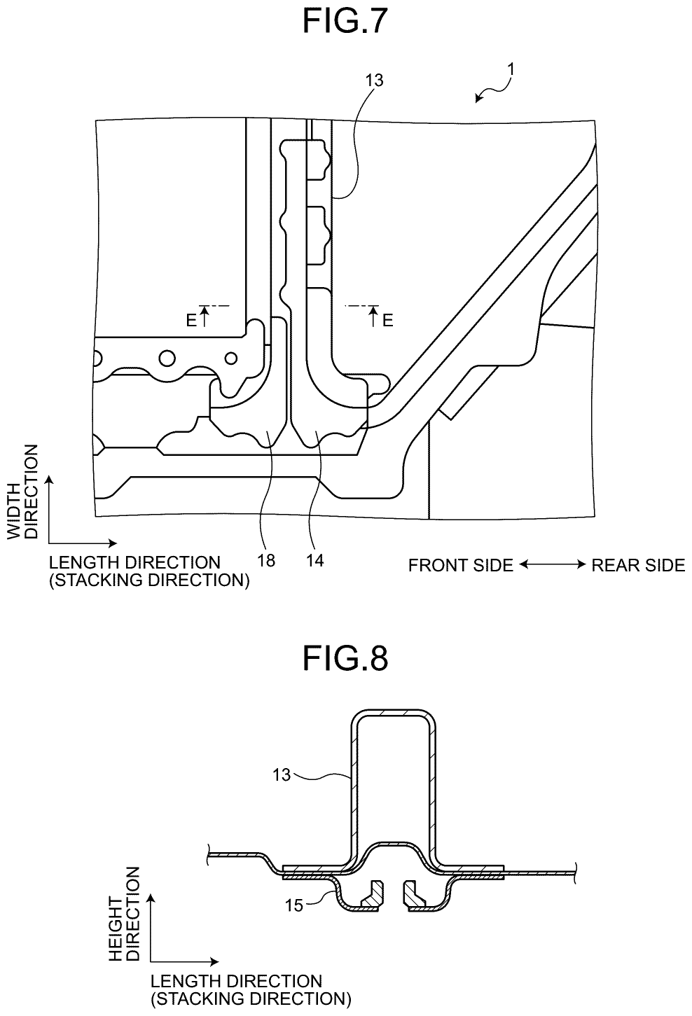

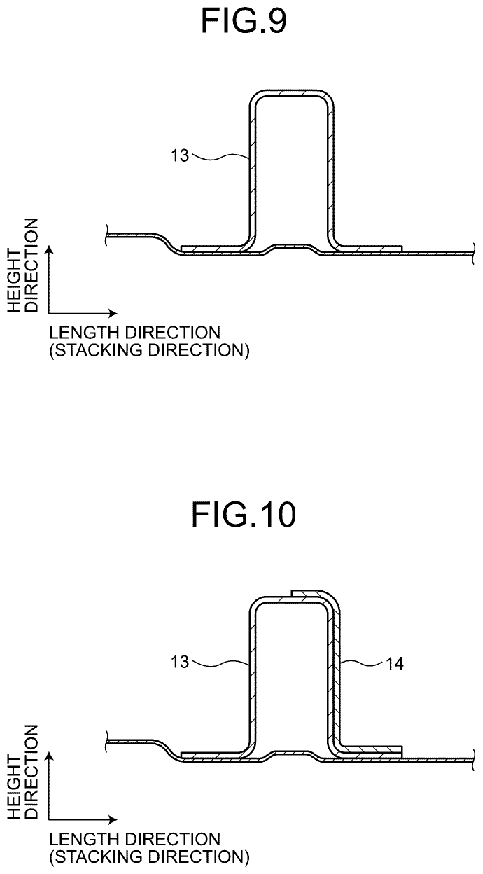

Here, FIG. 6 illustrates the configuration of a related-art battery pack 101. Further, FIG. 7 illustrates the configuration of the battery pack 1 according to the embodiment. Further, FIGS. 8 and 9 show the battery pack 101 of FIG. 6 cut at the state of C-C line and D-D line. Further, FIG. 10 illustrates a state in which the battery pack 1 of FIG. 7 is cut at the position of E-E line. The D-D line in FIG. 6 and the E-E line in FIG. 7 are at the same position.

In the related-art battery pack 101, for example, as illustrated in FIG. 8, the portion wrapped with the upper frame member 13 and the lower frame member 15, since the total plastic moment is high, even if the side impact load is input, buckling of the upper frame member 13 hardly occurs. In contrast, for example, as illustrated in FIG. 9, the upper frame member 13 and the lower frame member 15 and the portion that does not wrap, since the total plastic moment is low, when the side bump load is input, buckling of the upper frame member 13 (there is a risk of folding on the rear side of the vehicle).

On the other hand, in the battery pack 1 according to the embodiment, for example, as illustrated in FIG. 10, the upper frame member 13 and the lower frame member 15 and the unwrapped portion are reinforced by the reinforcing member 14. Thus, in the battery pack 1 according to the embodiment, a weak point portion with respect to the side thrust load, the portion without the lower frame member 15 (the direction in which the upper frame member 13 buckles) by reinforcing member 14 reinforces, it is possible to carry the side thrust load by the reinforcing member 14. Thus, it is possible to suppress buckling of the upper frame member 13.

Further effects and variations can be readily derived by one skilled in the art. Thus, the broader aspects of the present disclosure are not limited to the specific details and representative embodiments represented and described above. Accordingly, various changes may be made without departing from the spirit or scope of the overall disclosure concept defined by the appended claims and their equivalents.

According to the present disclosure, the portion without the lower frame member (the direction in which the upper frame member buckles) that becomes the weak point portion with respect to the side bump load is reinforced by the reinforcing member, it is possible to suppress the buckling of the upper frame member.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a plurality of battery cells stacked in a predetermined direction;
an upper frame member disposed above the battery cell; and
a lower frame member disposed below the battery cell, wherein
the upper frame member includes a reinforcing member extending in a direction perpendicular to a stacking direction of the battery cells, and
at least a part of the reinforcing member overlaps the lower frame member.

2. The battery pack according to claim 1, wherein
the upper frame member is provided on a side surface of the battery cells in the stacking direction, and
the reinforcing member is provided on outside of a battery cell closest to an end in the stacking direction.
